(19) United States
(12) Patent Application Publication
(10) Pub. No.: US 2010/0247075 A1
(43) Pub. Date: Sep. 30, 2010

(54) VIDEO/AUDIO RECORDING/REPRODUCING APPARATUS

(76) Inventors: Haruhiko Nakata, Osaka (JP); Hiroki Teshima, Kyoto (JP); Nobumasa Otsu, Osaka (JP); Kunio Dohno, Osaka (JP); Miki Shimizu, Osaka (JP); Yutaka Shimizu, Osaka (JP); Kentaro Hirao, Hyogo (JP); Kosai Ikegami, Kyoto (JP)

Correspondence Address: MCDERMOTT WILL & EMERY LLP, 600 13TH STREET, NW, WASHINGTON, DC, 20005-3096, US

(21) Appl. No.: 12/682,141

(22) PCT Filed: Aug. 25, 2008
(86) PCT No.: PCT/JP2008/002300

§ 371 Date: Apr. 8, 2010

(30) Foreign Application Priority Data
Oct. 10, 2007 (JP) 2007-264091

(51) Int. Cl. H04N 5/91

(52) U.S. Cl. 386/95; 386/E05.003

(57) ABSTRACT

A stream input unit (102) receives a transport stream. A subtitle information extracting unit (104) separates the received transport stream into subtitle information and information other than the subtitle information. Next, a stream format converting unit (105) converts separated video/audio information contained in the transport stream into a program stream of video/audio. A subtitle format converting unit (107) converts the subtitle information separated by the subtitle information extracting unit (104) into a program stream of subtitle information. Thereafter, a subtitle information inserting unit (108) inserts the subtitle information converted by the subtitle format converting unit (107) into the program stream converted by the stream format converting unit (105), and outputs the resultant program stream.

### TECHNICAL FIELD

The present invention relates to video/audio recording/reproducing apparatuses which record a transport stream containing subtitle information as a program stream.

### BACKGROUND ART

At present, DVD recorders employing a DVD or a hard disk as a recording medium are commonly and widely used as apparatuses for recording television-broadcast video and audio information (video/audio recording/reproducing apparatuses). Some of such recording apparatuses record subtitle information contained in a television broadcast (transport stream) as a program stream of subtitle information. For example, subtitle information superimposed during vertical blanking intervals of television broadcasting may be extracted and converted into bitmap data, the bitmap data is run-length compressed, and the resultant data is recorded as a program stream of subtitle information (see, for example, Patent Document 1).

### CITATION LIST

### Patent Document

PATENT DOCUMENT 1: Japanese Patent Laid-Open Publication No. 2000-23082

### SUMMARY OF THE INVENTION

### Technical Problem

However, conventional video/audio recording/reproducing apparatuses do not support digital television broadcasting having no vertical blanking interval. Therefore, when a transport stream of digital television broadcasting is converted into a program stream, and the program stream is recorded, subtitle information contained in the transport stream is recorded as a portion of video information in the program stream. In this case, it is not possible to switch between displaying and hiding the subtitle information during reproduction, which is a problem.

When there are a plurality of pieces of subtitle information, only subtitle information that is selected during recording can be recorded, and languages to be displayed during reproduction cannot be selected, which is another problem.

The present invention has been made to solve the aforementioned problems. It is an object of the present invention to make it possible to switch between displaying and hiding subtitle information and select languages to be displayed, when video and audio information contained in a transport stream which has been recorded as a program stream is reproduced.

### Solution to the Problem

To achieve the object, in the present invention, subtitle information contained in transport stream is converted into a program stream of subtitle information, and the program stream of subtitle information is recorded.

For example, a video/audio recording/reproducing apparatus according to an embodiment of the present invention is provided for recording a transport stream of subtitle information in a single or a plurality of languages into a storage medium, including a stream input unit configured to receive a transport stream containing program specifying information, subtitle information, and video/audio information, a subtitle information extracting unit configured to separate the transport stream received by the stream input unit into the subtitle information and the information other than the subtitle information, a stream format converting unit configured to convert the video/audio information of the transport stream separated by the subtitle information extracting unit into a program stream of video/audio, a subtitle format converting unit configured to convert the subtitle information separated by the subtitle information extracting unit into a program stream of subtitle information, a subtitle information inserting unit configured to insert the subtitle information converted by the subtitle format converting unit, into the program stream converted by the stream format converting unit, and a data recording unit configured to record the program stream output by the subtitle information inserting unit.

As a result, initially, a transport stream of video/audio information is converted into a program stream of video/audio by the stream format converting unit. Also, subtitle information in a single or a plurality of languages is converted into a program stream of subtitle information. Thereafter, the program stream of subtitle information is inserted into the program stream of video/audio, and the resultant program stream of video/audio is recorded. In other words, subtitle information contained in a transport stream is converted into a program stream of subtitle information, and the program stream of subtitle information is recorded.

### ADVANTAGES OF THE INVENTION

According to the present invention, subtitle information contained in a transport stream is converted into a program stream of subtitle information, and the program stream of subtitle information is recorded. Therefore, it is possible to switch between displaying and hiding the subtitle information and select languages to be displayed during playback.

### BRIEF DESCRIPTION OF THE DRAWINGS

FIG. 1 is a block diagram showing a configuration of a video/audio recording/reproducing apparatus 101 according to Embodiment 1 of the present invention.

FIG. 2 is a diagram showing a PES packet format of Subtitle which is transmitted in MPEG2-TS streams.

FIG. 3 is a diagram showing a format of a page composition segment.

FIG. 4 is a diagram showing a format of a region composition segment for a bitmap object.

FIG. 5 is a diagram showing a formant of a CLUT definition segment.

FIG. 6 is a formant of an object composition segment for a bitmap object.

FIG. 7 is a diagram showing a screen configuration in which Subtitle is displayed.

FIG. 8 is a diagram showing a sub picture format in DVD-VR streams.

FIG. 9 is a diagram showing an assignment table for pixel data of a sub picture.

FIG. 10 is a diagram showing a display control command format for determining color information of a sub picture.

FIG. 11 is a diagram showing a CLUT definition format of a sub picture.

FIG. 12 is a diagram showing a list of display control commands for a sub picture.

FIG. 13 is a diagram showing a display control command format for determining a display position of a sub picture.

FIG. 14 is a diagram showing a method of converting a 16-color CLUT into a 4-color CLUT.

FIG. 15 is a method showing a method of converting a 256-color CLUT into a 4-color CLUT.

FIG. 16 is a diagram showing table IDs of a 256-color CLUT designated by pixel data.

FIG. 17 is a diagram showing a method of reducing the number of table IDs of a CLUT designated by pixel data to four colors.

FIG. 18 is a diagram showing table IDs of a CLUT designated by pixel data, where the number of table IDs has been reduced to four colors.

FIG. 19 is a diagram showing a plurality of subtitle rectangular regions in Embodiment 2.

FIG. 20 is a diagram showing a method of inserting a sub picture pack in Embodiment 3.

### DESCRIPTION OF REFERENCE CHARACTERS

101 Video/Audio Recording/Reproducing Apparatus
102 Stream Input Unit
103 Program Specifying Information Acquiring Unit
104 Subtitle Information Extracting Unit
105 Stream Format Converting Unit
106 Time Information Acquiring Unit
107 Subtitle Format Converting Unit
108 Subtitle Information Inserting Unit
109 Data Recording Unit
201 Display Screen
202 Subtitle Rectangular Region
203 Subtitle Rectangular Region
204 Border Line
301 Program Stream
301a, 301b, 301c Video Pack
301d, 301e, 301f Audio Pack
302 Sub Picture Pack

### DESCRIPTION OF EMBODIMENTS

Embodiments of the present invention will be described hereinafter with reference to the accompanying drawings. Note that, in the description of the embodiments below, components having similar functions are indicated by the same reference characters and are not repeatedly described.

### Embodiment 1 of the Invention

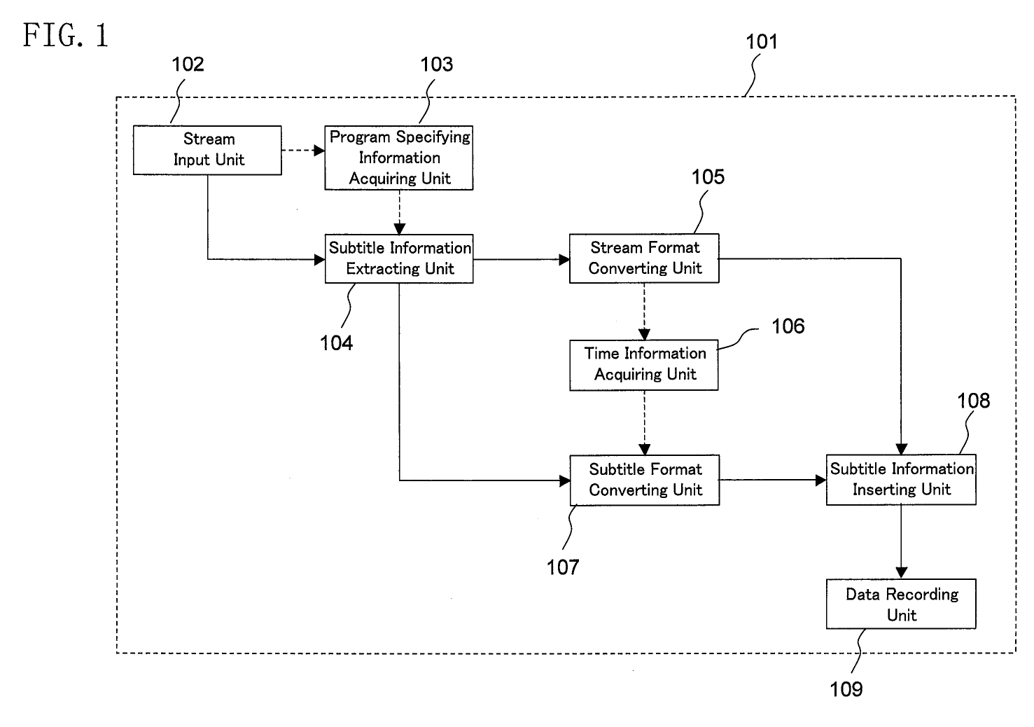

FIG. 1 is a block diagram showing a configuration of a video/audio recording/reproducing apparatus 101 according to Embodiment 1 of the present invention. The video/audio recording/reproducing apparatus 101 receives a transport stream containing video, audio, data, and subtitle information, and records or reproduces the transport stream as a program stream. In the description that follows, the transport stream input to the video/audio recording/reproducing apparatus 101 is assumed to be an MPEG2-TS (Transport Stream).

—Configuration of Video/Audio Recording/Reproducing Apparatus 101—

The video/audio recording/reproducing apparatus 101 includes a stream input unit 102, a program specifying information acquiring unit 103, a subtitle information extracting unit 104, a stream format converting unit 105, a time information acquiring unit 106, a subtitle format converting unit 107, a subtitle information inserting unit 108, and a data recording unit 109.

The stream input unit 102 receives an MPEG2-TS (Transport Stream) containing subtitle information output from a digital television broadcasting antenna, a player or the like, and outputs the received MPEG2-TS to the program specifying information acquiring unit 103 and the subtitle information extracting unit 104.

The program specifying information acquiring unit 103 acquires program specifying information which is contained in the MPEG2-T output by the stream input unit 102. In this example, the program specifying information acquiring unit 103 acquires a PAT (Program Association Table) and a PMT (Program Map Table) as program information. The program specifying information acquiring unit 103 also acquires PIDs (Packet IDs) which are identification information about video, audio, data, and subtitles, and information about the number of subtitle streams.

The subtitle information extracting unit 104 separates the MPEG2-TS received by the stream input unit 102 into TS packets of subtitle information (Subtitle) and TS packets of video and audio, based on the PIDs for video, audio, data, and subtitles which have been acquired by the program specifying information acquiring unit 103. In this case, the subtitle information extracting unit 104 extracts reproduction time control information. In this example, the reproduction time control information is a leading PTS (Presentation Time Stamp) of an MPEG2-TS from which recording operation of a digital television broadcast is started. The subtitle information extracting unit 104 notifies the subtitle format converting unit 107 of the reproduction time control information, and the number of pieces of subtitle identification information acquired from the program specifying information acquiring unit 103.

The stream format converting unit 105 converts the TS packets of video and audio separated by the subtitle information extracting unit 104 into an MPEG2-PS (Program Stream) conforming to the DVD-VR (Video Recording) standards. In this case, the stream format converting unit 105 inserts, into the converted MPEG2-PS, an empty pack for inserting a sub picture pack which is to be recorded as subtitle information. The empty pack is generated by back calculation from the recording rate of a video/audio stream of the MPEG2-PS so that the continuity between an SCR (System Clock Reference) of each packet of the MPEG2-PS is maintained for the number of packets allowed within a range which is limited by a maximum recording rate which is specified in the DVD-VR standards.

The time information acquiring unit 106 acquires the leading PTS of the MPEG2-PS converted by the stream format converting unit 105.

The subtitle format converting unit 107 converts the TS packets of Subtitle extracted by the subtitle information extracting unit 104 into a sub picture pack which is an MPEG2-PS of subtitle information. The details of the conversion method will be described later.

The subtitle information inserting unit 108 inserts information (a packet header, sub_stream_Id, sub picture data) other than the pack header of the empty pack inserted by the stream format converting unit 105, into the sub picture pack converted by the subtitle format converting unit 107.

The data recording unit 109 records the MPEG2-PS containing the sub picture pack output by the subtitle information inserting unit 108 into a storage medium (e.g., a DVD-RAM).

(Conversion Method in Subtitle Format Converting Unit 107)

The subtitle format converting unit 107, when Subtitle is an image (bitmap image), decompresses the bitmap image which is a run-length compressed MPEG2-TS, and run-length compresses the resultant bitmap image into a sub picture pack which is an MPEG2-PS again.

The subtitle format converting unit 107, when Subtitle is character information (character code), also converts a character code of Subtitle into a bitmap image using font data possessed by the video/audio recording/reproducing apparatus 101, and run-length compresses the bitmap image into a sub picture pack which is an MPEG2-PS.

The subtitle format converting unit 107 also converts a CLUT (Color Look Up Table) which is color display information of Subtitle, into a CLUT which is color display information of a sub picture conforming to the DVD-VR standards.

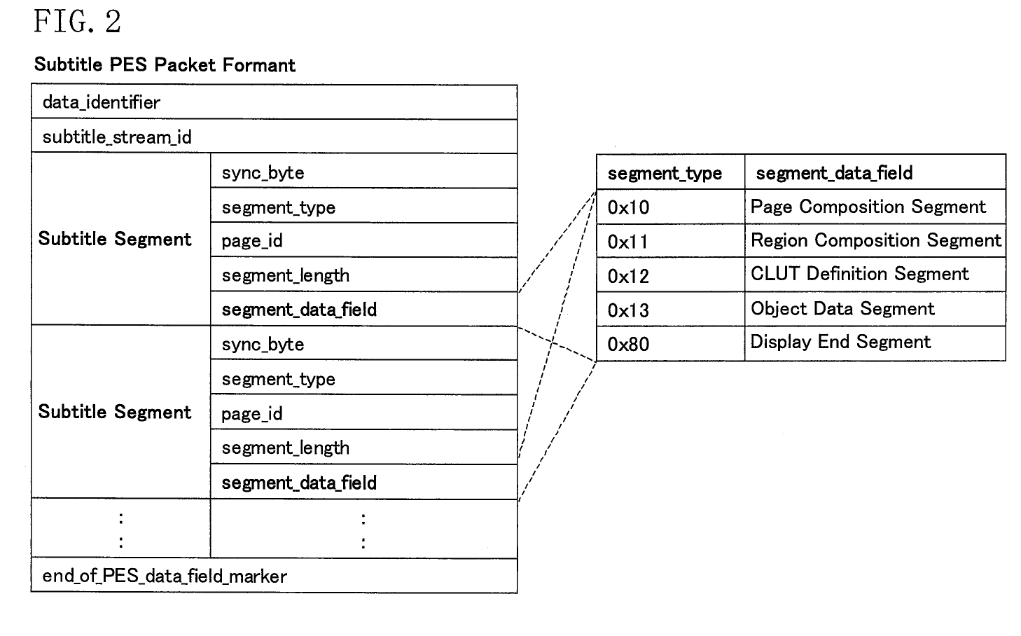

Here, Subtitle conforming to the DVB-T standards which is contained in MPEG2-TS streams will be described. FIG. 2 shows a PES packet format of Subtitle which is transmitted in MPEG2-TS streams.

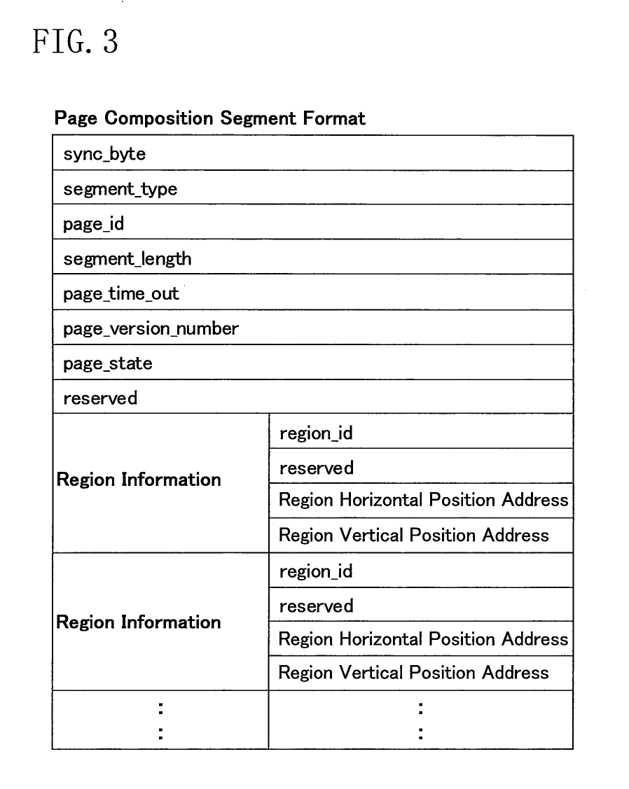

As shown in FIG. 2, a PES packet of Subtitle includes a page composition segment, a region composition segment, a CLUT definition segment, and an object data segment. FIGS. 3, 4, 5, and 6 show the format of the page composition segment, the format of the region composition segment in the case of a bitmap object, the format of the CLUT definition segment, and the format of the object data segment in the case of a bitmap object.

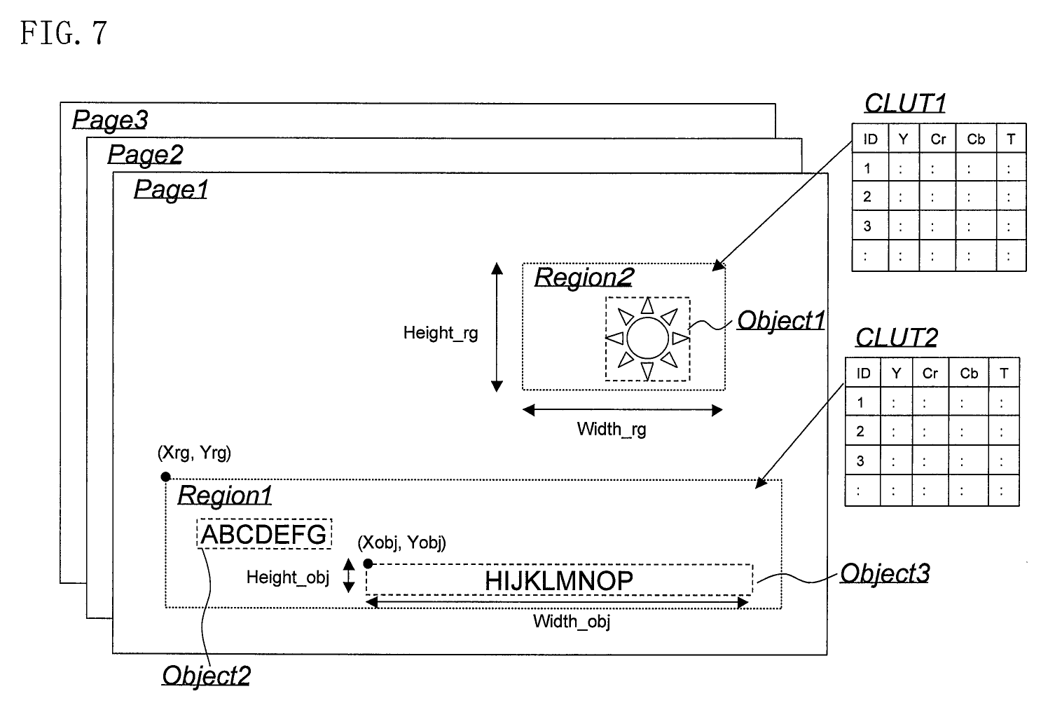

Here, as shown in FIG. 7, a screen configuration of Subtitle display includes a page, a region, and an object. A CLUT is defined for each region.

Pages are defined by data in the composition format (see FIG. 3). Each page can have a plurality of regions. Each region is identified by a region_id. A position (Xrg, Yrg) of each region is determined by a region horizontal position address and a region vertical position address in region information.

When a plurality of pages are present, any of the plurality of pages is displayed. A displayed page is switched to another page by selection by the user or the like. Specifically, a plurality of Subtitles in different languages are assigned to respective corresponding pages. When the Subtitle languages are switched, operation of switching the pages is performed.

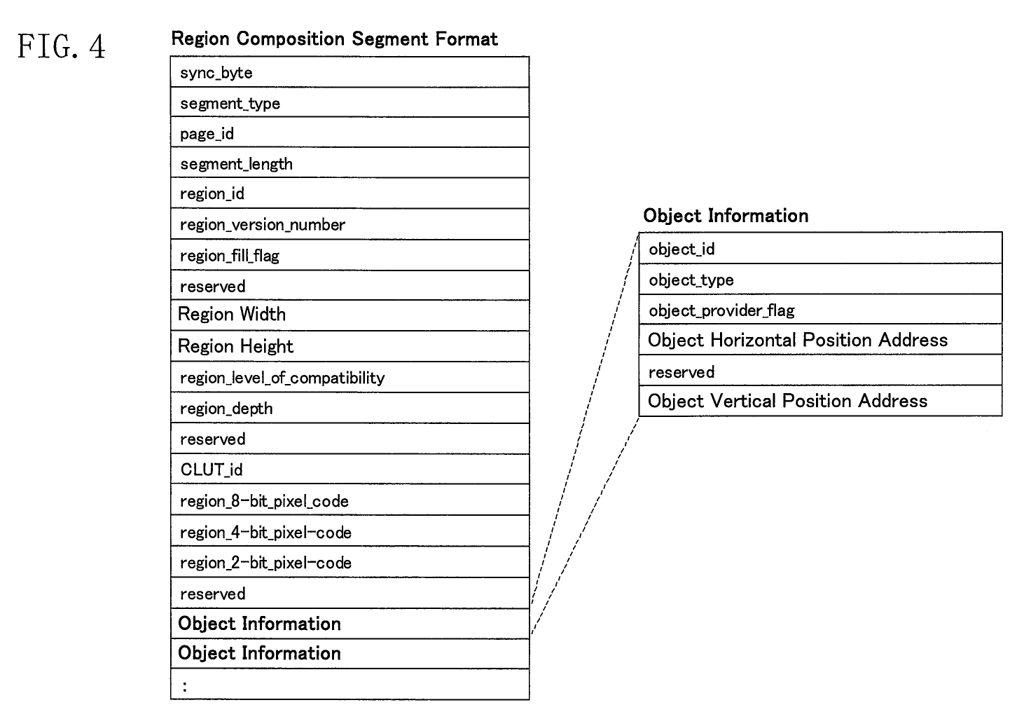

Regions are defined by data in the region composition segment format (see FIG. 4). A size (Width_rg, Height_rg) of a region is determined by a region width and a region height. A CLUT is defined for each region. A CLUT_id identifies a corresponding CLUT.

Moreover, each region can have a plurality of objects, which are identified by corresponding object_ids. A relative position (Xobj, Yobj) of an object in a region is determined by a horizontal position address and a vertical position address in object information.

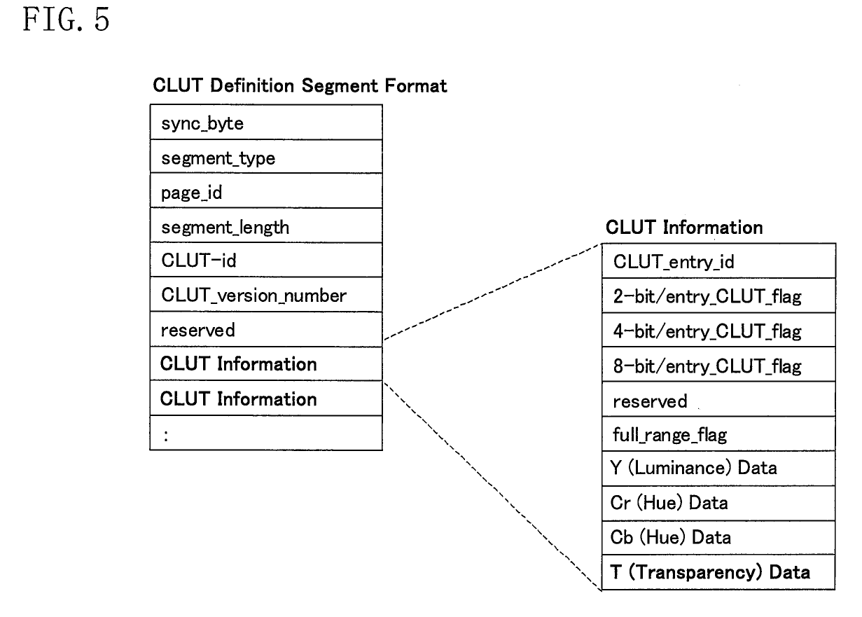

CLUTs are defined by data in the CLUT definition segment format (see FIG. 5). For each CLUT_id, table data including Y (luminance) data, Cr (hue) data, Cb (hue) data, and T (transparency) data is provided in association with a CLUT_entry_id. Object data includes pixel data using a CLUT_entry_id, and a color corresponding to the object data is determined from the CLUT.

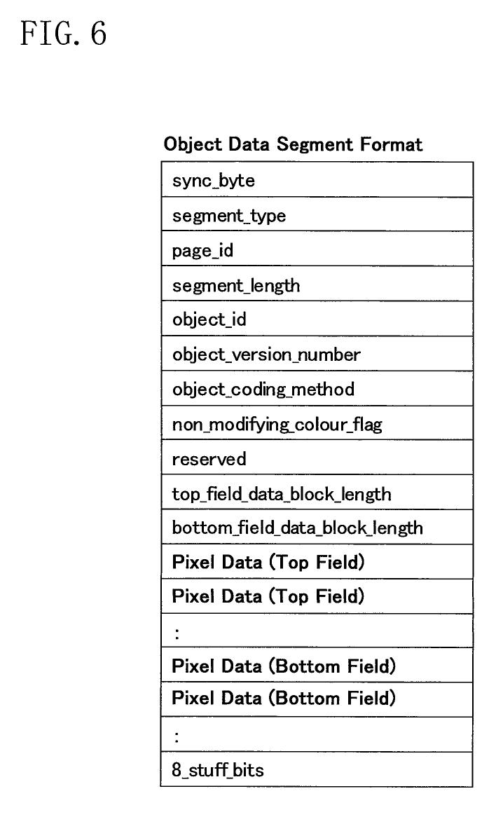

Objects are defined by data in the object data segment format (see FIG. 6). Pixel data, which is a substantial portion of each object, is run-length compressed data. The data is decompressed and supplied to a display area so that Subtitle is drawn.

Display is performed at a timing that an STC (System Time Clock) coincides with a PTS added to the packet header of a PES (Packetized Elementary Stream) of Subtitle. The STC is generated by a PCR (Program Clock Reference) transported in an MPEG2-TS stream. The page composition segment includes a “page_time_out” which is used to erase the display of an entire page.

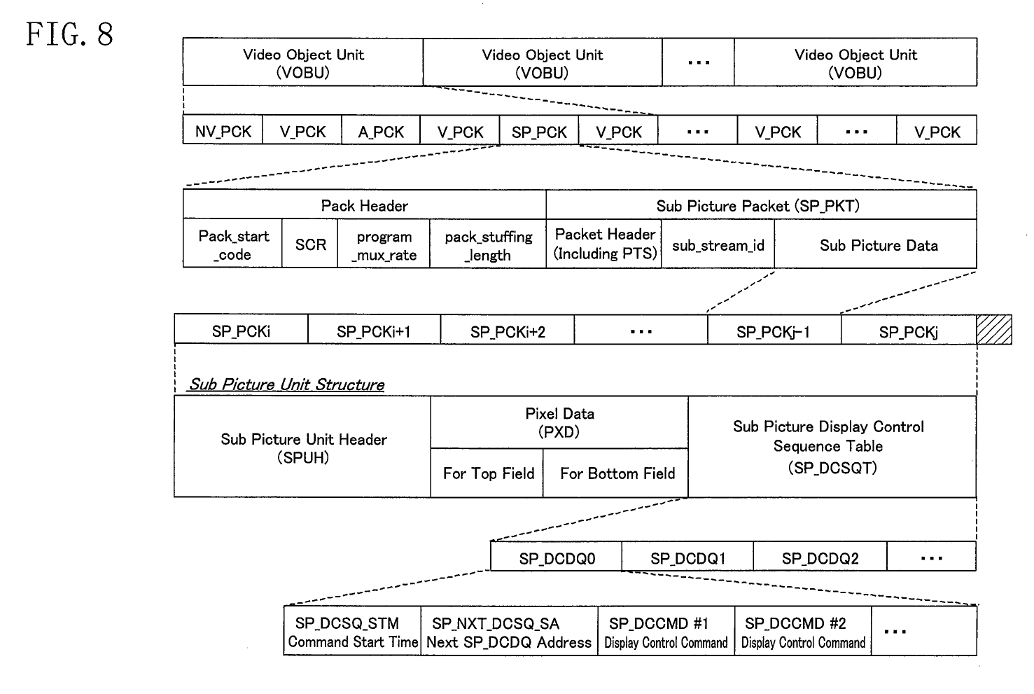

Next, sub pictures conforming to the DVD-VR (Video Recording) standards will be described with reference to FIG. 8. DVD-VR streams each include a plurality of VOBUs (Video object Units). Sub picture data is embedded as an SP_PCK in each VOBU. A unit of sub picture data contained in one VOBU is a sub picture unit.

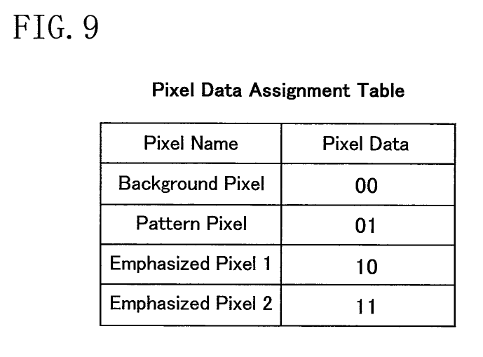

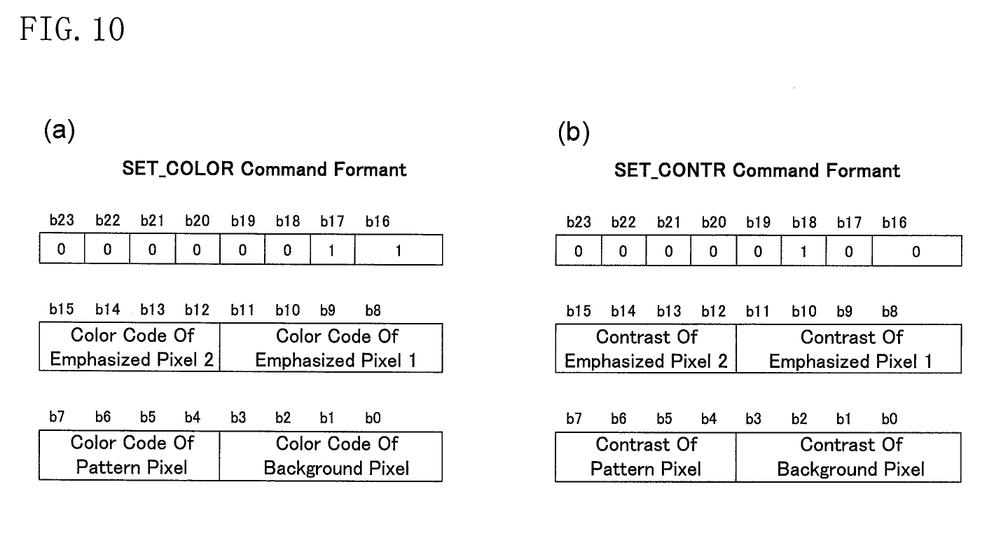

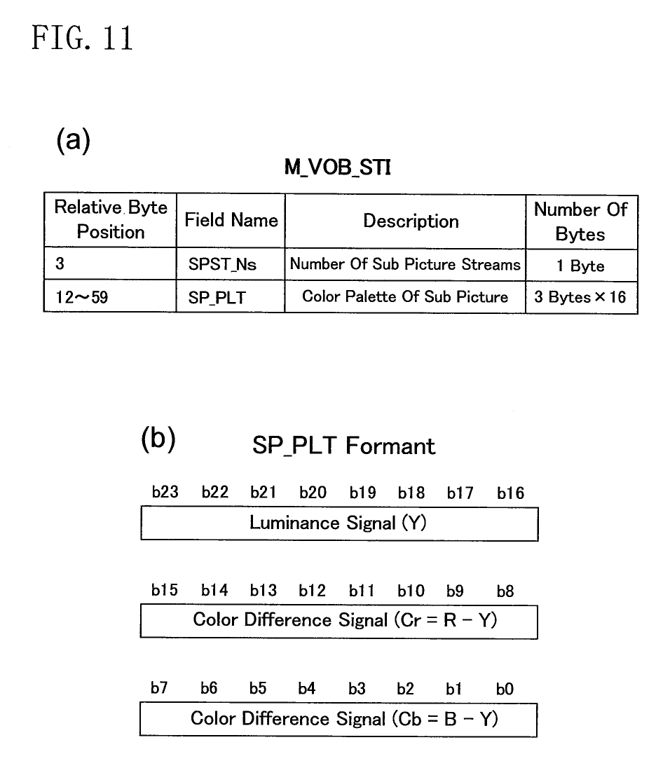

A PXD contained in each sub picture unit is the run-length compressed version of a sub picture to be displayed. The PXD is a set of data in which each two bits expresses one pixel as shown in FIG. 9. The pixel data of FIG. 9 is expressed by a color code of a SET_COLOR command and a contrast of a SET_CONTR command described in FIG. 10. The color code corresponds to Y, Cr, and Cb of a CLUT of an SP_PLT defined in M_VOB_STI (VOB stream information: RTR_VMG->M_AVFIT->M_VOB_STI) shown in FIG. 11. The contrast is used as data indicating a mixture ratio with respect to main video. In other words, two-bit pixel data included in the PXD is eventually converted into Y, Cr, Cb and a contrast.

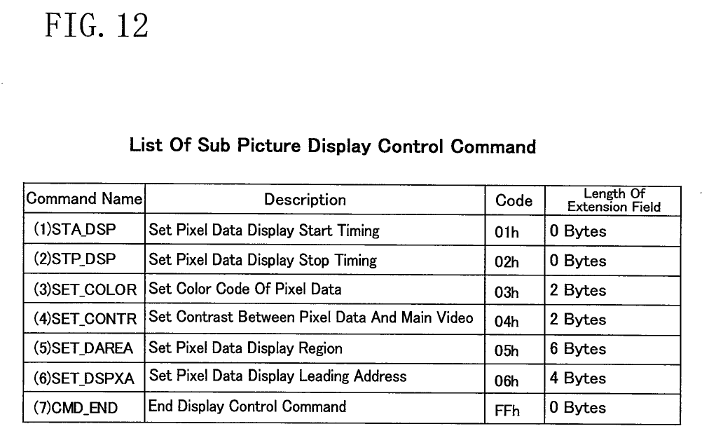

FIG. 12 shows a list of sub picture display control commands. The display timing of a sub picture is controlled by an STA_DSP command and an STP_DSP command shown in FIG. 12. The STA_DSP command is executed at a timing that a time which is obtained by adding an SP_DCSQ_STM (command start time) of an SP_DCDQ to a PTS added to a sub picture packet of FIG. 8 coincides with an STC, thereby displaying a sub picture. Similarly, the STP_DSP command is executed at a timing that a time which is obtained by adding an SP_DCSQ_STM (command start time) of an SP_DCDQ to a PTS added to a sub picture packet coincides with an STC, thereby erasing a sub picture.

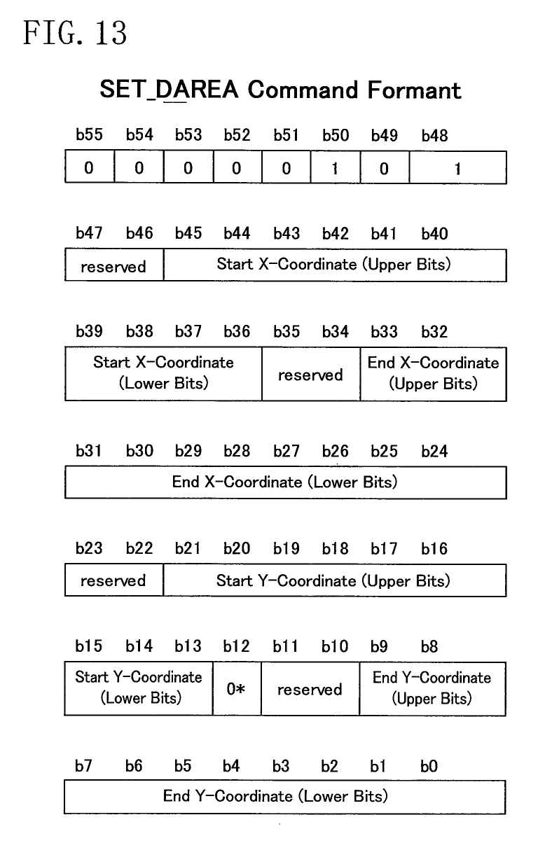

A display position of a sub picture is controlled by a SET_DAREA command shown in FIG. 13. A sub picture is displayed in a rectangular region indicated by the X and Y coordinates of the start and end of this command.

When a plurality of sub picture streams are present, the number of sub picture streams is defined by an SPST_Ns defined in M_VOB_STI (VOB stream information: RTR_VMG->M_AVFIT->M_VOB_STI) of FIG. 11, and the sub picture streams are identified by sub_stream_ids in an SP_PCK of FIG. 8. Sub pictures in different languages can be displayed by designating corresponding sub_stream_ids.

These basic sub picture control methods are similar to those in the DVD-Video standards.

A method of converting Subtitle conforming to the DVB-T standards into a sub picture conforming to the DVD-VR standards will be described hereinafter.

The number of sub picture streams needs to be designated to an SPST_Ns. Therefore, the number of streams of Subtitle contained in an MPEG2-TS acquired from the program specifying information acquiring unit 103 is designated to the SPST_Ns.

A sub_stream_id needs to be assigned to each sub picture. Sub_stream_ids are each 8-bit data, which needs to be in the format “0b001***** (* indicates any of 0 or 1)” in binary notation. Therefore, the numbers 1, 2, 3 and so on are assigned to “*****” in this stated order, depending on the number of streams of Subtitle contained in an MPEG2-TS acquired from the program specifying information acquiring unit 103.

Next, a method of generating a display region of a sub picture will be described. A display position and a display range of a region are acquired from a region horizontal position address and a region vertical position address indicated in the page composition segment format and a region width and a region height indicated in the region composition segment format, and are converted into a sub picture display control command SET_DAREA conforming to the DVD-VR standards. The region horizontal position address is set to the start X-coordinate of SET_DAREA, and a value which is obtained by adding the region width to the region horizontal position address is set to the end X-coordinate of SET_DAREA. The region vertical position address is set to the start Y-coordinate of SET_DAREA, and a value which is obtained by adding the region height to the region vertical position address is set to the end Y-coordinate of SET_DAREA.

When a plurality of regions are simultaneously displayed, the smallest value of the horizontal position addresses of the regions is set to the start X-coordinate of SET_DAREA, and the greatest one of the values which are obtained by adding the horizontal position addresses of the regions to the region widths of the regions is set to the end X-coordinate of SET_DAREA. The smallest value of the vertical position addresses of the regions is set to the start Y-coordinate of SET_DAREA, and the greatest one of the values which are obtained by adding the vertical position addresses of the regions to the region heights of the regions is set to the end Y-coordinate of SET_DAREA.

Next, a method of generating a display time of a sub picture will be described. In the DVB-T standards, subtitles are displayed in synchronization with a PTS in a stream. Therefore, also in the DVD-VR standards, the display of a sub picture may be started in synchronization with a PTS in a stream. Therefore, the SP_DCSQ_STM is set to 0 so that the SP_DCSQ_STM is the same time as a PTS at which a sub picture is contained. By executing the STA_DSP command at the SP_DCSQ_STM time, the sub picture is displayed in synchronization with the PTS. A page_time_out time is used as a display end time. The page_time_out time is expressed in Subtitle by an offset from a time that display is started. Therefore, the SP_DCSQ_STM is set to a value which is calculated in units of 90 KHz so that the SP_DCSQ_STM is the same time as the page_time_out, and the STP_DSP command is executed at the SP_DCSQ_STM time.

Next, a method of generating color display information about a sub picture will be described. The color display information used in Subtitle is specified in CLUT information corresponding a CLUT_id in a region composition segment.

It is determined whether a CLUT used in Subtitle is a 4-color CLUT, a 16-color CLUT, or a 256-color CLUT, based on a 2-bit/entry_CLUT_flag, a 4-bit/entry_CLUT_flag, and an 8-bit/entry_CLUT_flag of the CLUT information. If the 2-bit/entry_CLUT_flag is true, the CLUT is a 4-color CLUT. If the 4-bit/entry_CLUT_flag is true, the CLUT is a 16-color CLUT. If the 8-bit/entry_CLUT_flag is true, the CLUT is a 256-color CLUT. When the CLUT is a 16-color or 256-color CLUT, the CLUT is converted into a 4-color CLUT.

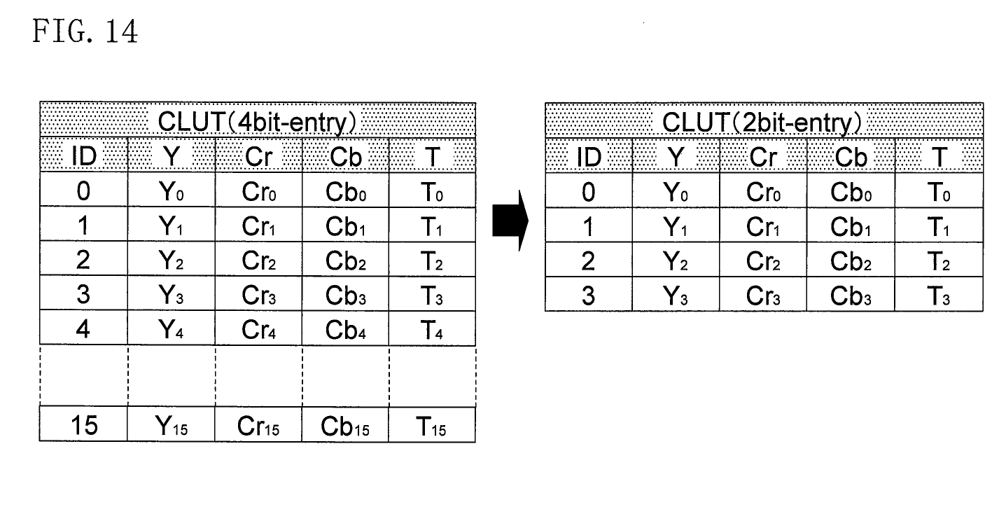

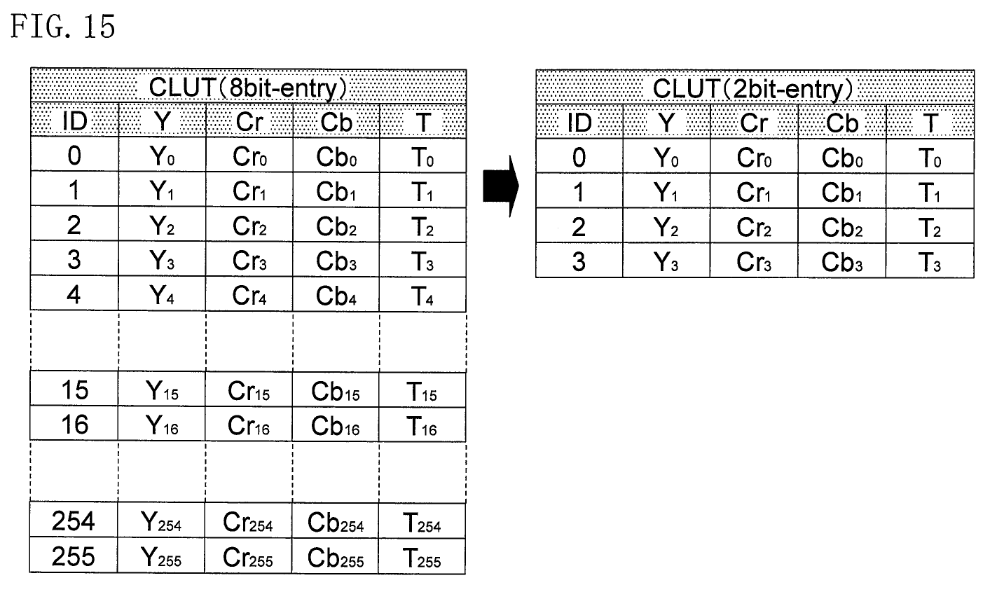

FIG. 14 shows a method of converting a 16-color CLUT into a 4-color CLUT. FIG. 15 shows a method of converting a 256-color CLUT into a 4-color CLUT. In both cases, color information (Y/Cr/Cb/T) located at tables corresponding to the IDs 0, 1, 2, and 3 of a CLUT is used as a 4-color CLUT.

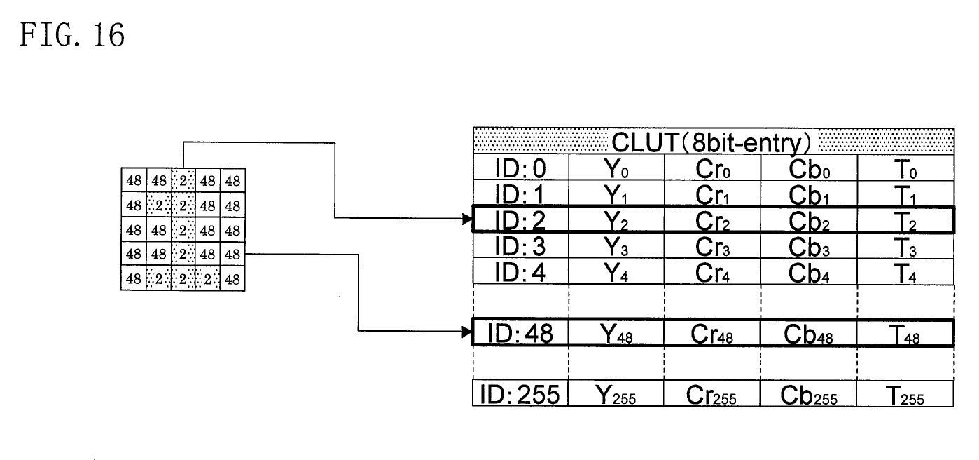

FIG. 16 is a diagram showing a relationship between table IDs of a CLUT indicated by pixel data contained in the object data segment of Subtitle, and the CLUT. Here, the CLUT designated by the CLUT_id of a region composition segment is assumed to be an 8-bit/entry (a 256-color CLUT). When a CLUT is converted into one which is used for a sub picture, a table ID of the CLUT designated by pixel data is also converted because the number of colors of the CLUT is reduced to four.

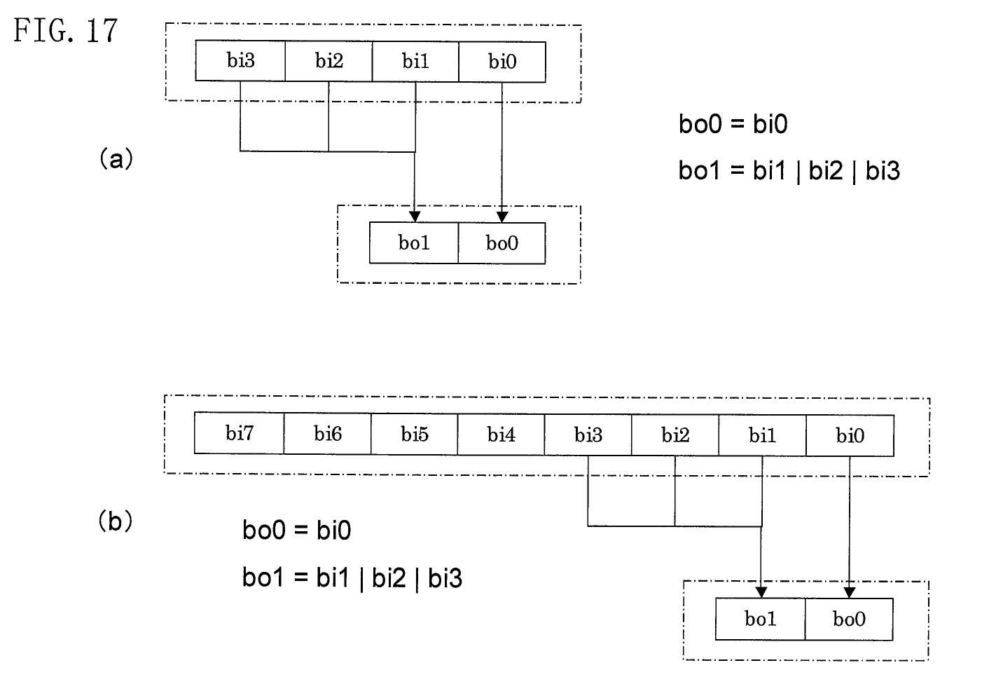

FIG. 17 shows a method of converting a table ID of a CLUT designated by pixel data. A portion (a) of FIG. 17 shows a method of converting a table ID of a CLUT designated by pixel data when a 16-color CLUT is converted into a 4-color CLUT. A portion (b) of FIG. 17 shows a method of converting a table ID of a CLUT designated by pixel data when a 256-color CLUT is converted into a 4-color CLUT.

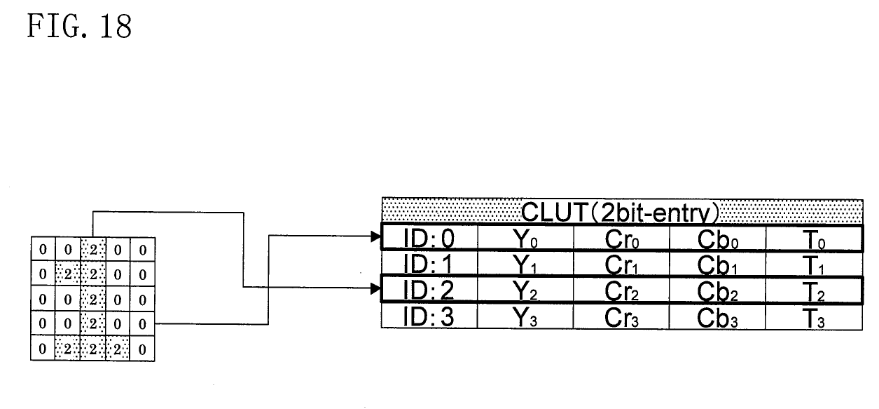

FIG. 18 shows the result from the conversion of a table ID of a CLUT designated by pixel data of FIG. 16. A table ID of a CLUT designated by pixel data is converted into a table ID of a CLUT having a reduced number of colors (i.e., a 4-color CLUT) by using the conversion method of FIG. 17.

The CLUT having a reduced number of colors (i.e., a 4-color CLUT) of Subtitle, when being converted into a CLUT of a sub picture, is inserted to an SP_PLT of a sub picture pack, excluding T, by the subtitle format converting unit 107.

A color of a sub picture is actually designated as follows. The four colors of the converted CLUT are assigned as color codes of SET_COLOR commands to a background color, a pattern color, an emphasized color 1, and an emphasized color 2. A value of T of a CLUT corresponding to a color designated by each SET_COLOR command is used as a SET_CONTR command.

A method of determining a PTS for a sub picture will be described hereinafter. A PTS for a sub picture pack of an MPEG2-PS generated by the subtitle format converting unit 107 is determined by subtracting a difference between the leading PTS of the MPEG2-TS extracted by the subtitle information extracting unit 104 and the leading PTS of the MPEG2-PS acquired by the time information acquiring unit 106 from the PTS for the sub picture pack of the MPEG2-PS generated by the subtitle format converting unit 107.

—Operation of Video/Audio Recording/Reproducing Apparatus 101—

In the video/audio recording/reproducing apparatus 101, the stream input unit 102 receives an MPEG2-TS and outputs the received MPEG2-TS to the program specifying information acquiring unit 103 and the subtitle information extracting unit 104.

The program specifying information acquiring unit 103 receives the output of the stream input unit 102 and acquires a PAT and a PMT contained in the MPEG2-TS. The program specifying information acquiring unit 103 also acquires PIDs which are identification information about video, audio, data, and subtitles, and information about the number of subtitle streams.

The subtitle information extracting unit 104 separates the MPEG2-TS into TS packets of Subtitle (subtitle information) and TS packets of video and audio, based on the PIDs acquired by the program specifying information acquiring unit 103. In this case, the subtitle information extracting unit 104 also extracts the leading PTS of the MPEG2-TS.

The stream format converting unit 105 receives the output of the subtitle information extracting unit 104, and converts the TS packets of video/audio separated by the subtitle information extracting unit 104 into an MPEG2-PS conforming to the DVD-VR standards. In this case, the stream format converting unit 105 inserts, into the converted MPEG2-PS, an empty pack for inserting a sub picture pack which is to be recorded as subtitle information.

The time information acquiring unit 106 acquires the leading PTS of the MPEG2-PS converted by the stream format converting unit 105.

The subtitle format converting unit 107 converts the TS packets of Subtitle extracted by the subtitle information extracting unit 104 into a sub picture pack which is an MPEG2-PS of subtitle information. In this case, in order to determine the PTS for the sub picture, the leading PTS of the MPEG2-TS extracted by the subtitle information extracting unit 104 and the leading PTS of the MPEG2-PS acquired by the time information acquiring unit 106 are used.

The subtitle information inserting unit 108 inserts information (a packet header, a sub_stream_Id, sub picture data) other than the pack header of the empty pack inserted by the stream format converting unit 105, into the sub picture pack converted by the subtitle format converting unit 107. As a result, the subtitle information inserting unit 108 outputs an MPEG2-PS containing the sub picture pack.

The data recording unit 109 records the MPEG2-PS output by the subtitle information inserting unit 108 to a storage medium (in this example, a DVD-RAM).

As described above, according to this embodiment, subtitle information contained in a transport stream is converted into a program stream of subtitle information, and the program stream of subtitle information is recorded. Therefore, it is possible to switch between displaying and hiding the subtitle information and select languages to be displayed during reproduction.

### Embodiment 2 of the Invention

A video/audio recording/reproducing apparatus according to Embodiment 2 of the present invention converts only specific subtitles into a sub picture pack, and records the sub picture pack.

The video/audio recording/reproducing apparatus of Embodiment 2 has the same components as those of the video/audio recording/reproducing apparatus 101 (Embodiment 1), but the subtitle format converting unit 107 has a different function. Specifically, the subtitle format converting unit 107 of this embodiment, when recording a sub picture conforming to the DVD-VR standards, converts only a subtitle rectangular region (Subtitle rectangular region) located below a designated border line into a sub picture pack.

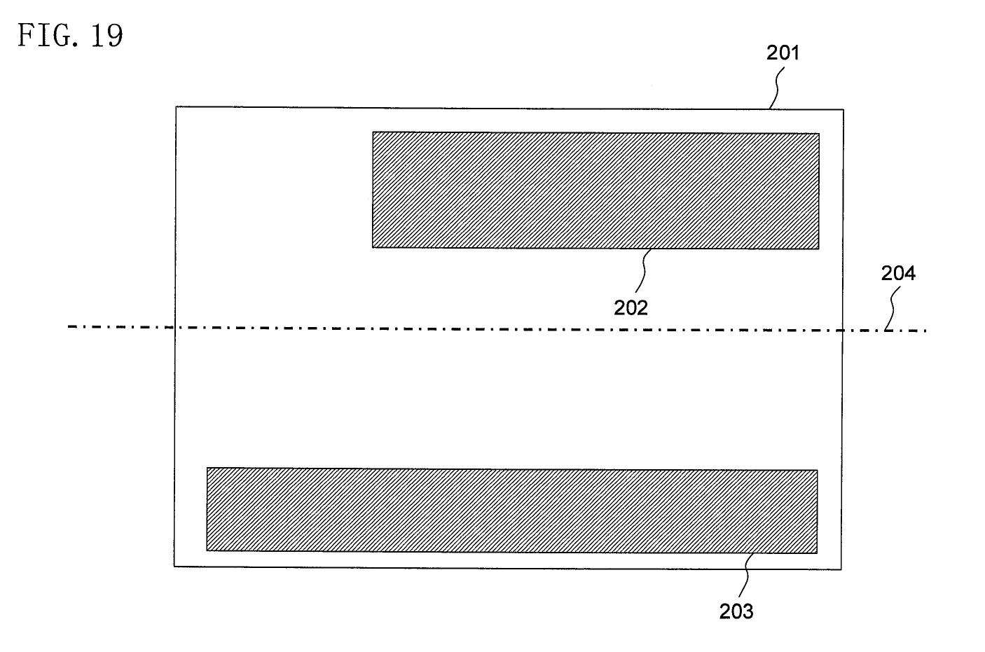

For example, FIG. 19 shows example subtitles broadcast by digital television broadcasting. In this example, two subtitle rectangular regions 202 and 203 are provided on a display screen 201. If a border line 204 is designated as the aforementioned border line, the video/audio recording/reproducing apparatus of this embodiment converts only the subtitle rectangular region 203 (Subtitle rectangular region) located below the border line 204 into a sub picture pack.

Therefore, according to this embodiment, subtitle information to be recorded into a storage medium can be selected and recorded by converting only subtitle information located within a specific range into a sub picture pack.

Note that a subtitle rectangular region to be recorded is selected based on a designated border line in this embodiment. Alternatively, a subtitle rectangular region to be recorded may be selected based on a display range or the area of the subtitle rectangular region.

### Embodiment 3 of the Invention

A video/audio recording/reproducing apparatus according to Embodiment 3 of the present invention inserts a sub picture pack into an MPEG2-PS without generating an empty pack in the stream format converting unit 105. The video/audio recording/reproducing apparatus of Embodiment 3 has the same components as those of the video/audio recording/reproducing apparatus 101 (Embodiment 1), but the subtitle information inserting unit 108 has a different function.

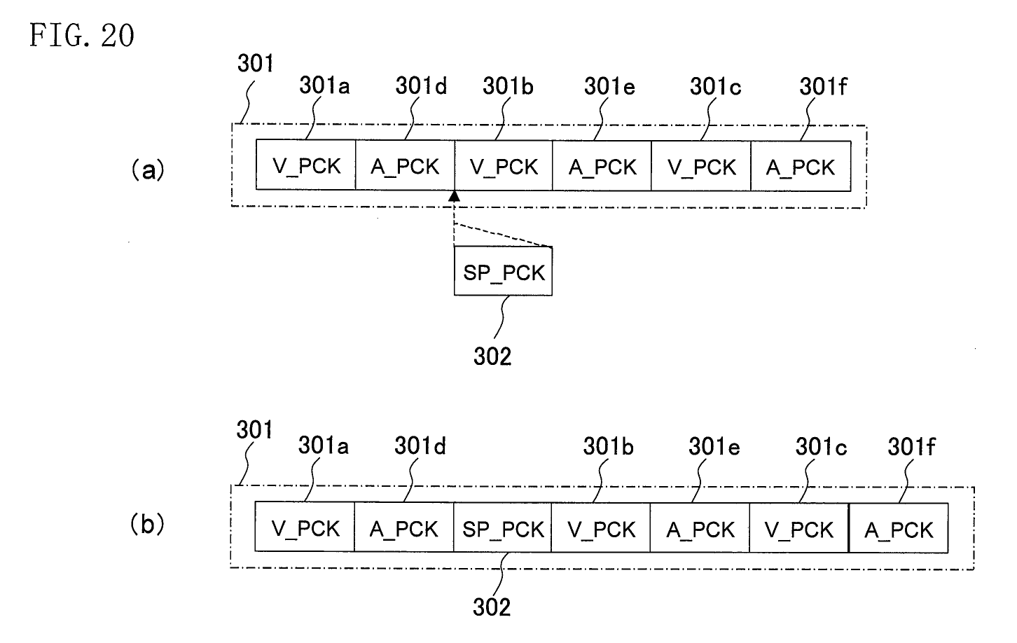

FIG. 20 shows a method of inserting a sub picture pack into an MPEG2-PS in this embodiment.

A program stream 301 shown in FIG. 20 is an MPEG2-PS generated by the stream format converting unit 105. A sub picture pack 302 (SP_PCK) is one which is generated by the subtitle format converting unit 107. In the program stream 301, video packs 301a, 301b, and 301c (V_PCKs) are video information, and audio packs 301d, 301e, and 301f (A_PCKs) are audio information. A portion (a) of FIG. 20 indicates an MPEG2-PS before inserting the sub picture pack 302, and a portion (b) of FIG. 20 indicates an MPEG2-PS after inserting the sub picture pack 302.

For example, when the sub picture pack 302 is inserted between the audio pack 301d and the video pack 301b, the SCR of the sub picture pack 302 needs to be selected so that the continuity of SCRs is established between the audio pack 301d, the sub picture pack 302, and the video pack 301b. Therefore, the subtitle information inserting unit 108 of this embodiment selects an average value of the SCRs of the audio pack 301d and the video pack 301b as the SCR of the sub picture pack 302.

As described above, according to this embodiment, by selecting an average value of the SCRs of packs before and after an inserted sub picture pack as the SCR of the sub picture pack, an empty pack for inserting a sub picture pack does not have to be generated. In this case, the continuity of SCRs before and after the inserted sub picture pack can be maintained.

Although an average value of the SCRs of packs before and after an inserted sub picture pack is selected as the SCR of the sub picture pack in this embodiment, selecting means other than the average value may be used.

Although a DVD-RAM is used as the storage medium recorded by the data recording unit 109 in each of the embodiments described above, a storage medium such as a DVD-R, a DVD-RW, a DVD+R, a DVD+RW, an HD (Hard Disc) or the like may be used, or alternatively, a semiconductor memory such as an SD memory card (Secure Digital memory card), a USB (Universal Serial Bus) memory or the like may be used.

Although the DVD-VR standards are used as an application format of a DVD to be recorded in each of the embodiments described above, other application formats having subtitle information, such as the DVD-Video standards, the DVD+VR (Video Recording) standards, or the like, may be used.

Although the DVB-T standards are used for a stream to be input to the stream input unit 102 in each of the embodiments described above, other stream standards such as the ARIB standards, the H.264 standards, or the like may be used.

### INDUSTRIAL APPLICABILITY

In the video/audio recording/reproducing apparatus of the present invention, subtitle information contained in a transport stream is converted into a program stream of subtitle information, and the program stream of subtitle information is recorded. As a result, it is advantageously possible to switch between displaying and hiding the subtitle information and select languages to be displayed during reproduction. Therefore, the present invention is useful for video/audio recording/reproducing apparatuses which record a transport stream containing subtitle information as a program stream, and the like.

1. A video/audio recording/reproducing apparatus for recording a transport stream of subtitle information in a single or a plurality of languages into a storage medium, comprising:
a stream input unit configured to receive a transport stream containing program specifying information, subtitle information, and video/audio information;
a subtitle information extracting unit configured to separate the transport stream received by the stream input unit into the subtitle information and the information other than the subtitle information;
a stream format converting unit configured to convert the video/audio information of the transport stream separated by the subtitle information extracting unit into a program stream of video/audio;
a subtitle format converting unit configured to convert the subtitle information separated by the subtitle information extracting unit into a program stream of subtitle information;
a subtitle information inserting unit configured to insert the subtitle information converted by the subtitle format converting unit, into the program stream converted by the stream format converting unit; and
a data recording unit configured to record the program stream output by the subtitle information inserting unit.

2. The video/audio recording/reproducing apparatus of claim 1, further comprising:
a program specifying information acquiring unit configured to acquire the program specifying information of the transport stream received by the stream input unit,
wherein
the subtitle information extracting unit uses the program specifying information to separate the transport stream into the subtitle information in a single or a plurality of languages and the information including the video/audio information other than the subtitle information.

3. The video/audio recording/reproducing apparatus of claim 2, further comprising:
a time information acquiring unit configured to acquire reproduction time control information provided at a header of the program stream converted by the stream format converting unit, and notify the subtitle format converting unit of the reproduction time control information,
wherein
the program specifying information acquiring unit is configured to notify the subtitle information extracting unit of the reproduction time control information of the transport stream and the number of pieces of subtitle identification information,
the subtitle information extracting unit is configured to acquire the reproduction time control information, and notify the subtitle format converting unit of the number of pieces of subtitle identification information, and
the subtitle format converting unit is configured to use the notified reproduction time control information and the notified number of pieces of subtitle identification information to convert the subtitle information in a single or a plurality of languages into a program stream of subtitle information.

4. The video/audio recording/reproducing apparatus of claim 1, wherein
the stream format converting unit has a function of generating an empty pack for inserting subtitle information into a program stream, and is capable of selecting whether to generate the empty pack.

5. The video/audio recording/reproducing apparatus of claim 4, wherein
the stream format converting unit generates the empty pack for inserting subtitle information into a program stream to adjust a rate at which video and audio are recorded within a range required by specifications.

6. The video/audio recording/reproducing apparatus of claim 4, wherein
the stream format converting unit calculates the number of empty packs which can be inserted within a range required by specifications for a program stream, based on a rate at which video and audio are recorded, and generates the number of empty packs.

7. The video/audio recording/reproducing apparatus of claim 1, wherein
the subtitle format converting unit converts subtitle information to be displayed in a single or a plurality of regions and subtitle information in a plurality of languages into a program stream of subtitle information.

8. The video/audio recording/reproducing apparatus of claim 7, wherein
the subtitle format converting unit generates identification information for a program stream of subtitle information the number of which is equal to the number of pieces of subtitle identification information in a transport stream, and converts the identification information for a program stream of subtitle information into a program stream.

9. The video/audio recording/reproducing apparatus of claim 8, wherein
the subtitle format converting unit, when a plurality of pieces of subtitle information are contained in a piece of subtitle information designated by subtitle identification information, generates identification information for a program stream of subtitle information the number of which is equal to the number of the plurality of pieces of subtitle information, and converts the identification information for a program stream of subtitle information into a program stream.

10. The video/audio recording/reproducing apparatus of claim 7, wherein
the subtitle format converting unit calculates a difference between reproduction time control information provided at a header of a program stream and reproduction time control information provided at a header of a transport stream, and adds or subtracts the difference to or from reproduction time control information for a transport stream of subtitle information, to generate reproduction time control information for a program stream of subtitle information.

11. The video/audio recording/reproducing apparatus of claim 7, wherein
the subtitle format converting unit converts subtitle information which satisfies a predetermined condition, of subtitle information contained in a transport stream, into a program stream of subtitle information.

12. The video/audio recording/reproducing apparatus of claim 7, wherein
the subtitle format converting unit generates color display information for displaying a program stream of subtitle information based on color display information contained in subtitle information contained in a transport stream.

13. The video/audio recording/reproducing apparatus of claim 7, wherein
the subtitle format converting unit decompresses a bitmap of the transport stream of subtitle information which is compressed by a compression method for the transport stream of subtitle information, reconstructs the bitmap image based on color display information for the program stream, and recompresses the bitmap image using a compression method for the program stream of subtitle information, to generate the program stream of subtitle information.

14. The video/audio recording/reproducing apparatus of claim 7, wherein
the subtitle format converting unit generates display control information for a program stream of subtitle information based on display control information for a transport stream of subtitle information.

15. The video/audio recording/reproducing apparatus of claim 14, wherein
the subtitle format converting unit calculates and generates a display coordinate and a display region of a program stream of subtitle information based on a display coordinate and a display region of a transport stream of subtitle information.

16. The video/audio recording/reproducing apparatus of claim 14, wherein
the subtitle format converting unit converts a plurality of pieces of subtitle information to be displayed at a plurality of positions, of a transport stream of subtitle information, as a single piece of subtitle information into a program stream of subtitle information.

17. The video/audio recording/reproducing apparatus of claim 4, wherein
the subtitle information inserting unit, when the program stream of subtitle information generated by the subtitle format converting unit is present in the empty pack, replaces a portion other than a header of the empty pack with subtitle information, and when the program stream of subtitle information is not present, replaces the portion other than the header of the empty pack with null data.

18. The video/audio recording/reproducing apparatus of claim 4, wherein
the subtitle information inserting unit, when the empty pack is not present in the program stream output by the stream format converting unit, inserts the program stream of subtitle information output by the subtitle format converting unit, as a subtitle information pack, into between video or audio packs of the program stream output by the stream format converting unit.

19. The video/audio recording/reproducing apparatus of claim 18, wherein
the subtitle information inserting unit calculates and generates time reference information of the program stream of subtitle information to be inserted, based on time reference information of video or audio packs before and after the program stream of subtitle information to be inserted.
